(19) United States
(12) Patent Application Publication
(10) Pub. No.: US 2005/0134194 A1
(43) Pub. Date: Jun. 23, 2005

(54) LIGHT CONTROLLER, ITS METHOD, ITS PROGRAM, RECORDING MEDIUM STORING THE PROGRAM AND DISPLAY CONTROLLER

(75) Inventor: Toshiyuki MURATA, Kawagoe-shi, Saitama (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: PIONEER CORPORATION, Tokyo (JP)

(21) Appl. No.: 10/905,104

(22) Filed: Dec. 15, 2004

(30) Foreign Application Priority Data
Dec. 18, 2003 (JP) 2003-420406

(51) Int. Cl. H05B 37/02

(52) U.S. Cl. 315/221

(57) ABSTRACT

By detecting surrounding illuminance with a reception unit (340) provided on a display controller (300), a change in the illuminance is recognized. A microcomputer (370) determines presence/absence of user's input operation through a terminal operating section (330) of a display controller (300). When recognizing the input operation, the microcomputer (370) restricts a process of calculating, with a luminance controller (360), a luminance control value that sets the luminance of an image display (320) to the luminance corresponding to a change in the illuminance and outputting the luminance control value to the image display (320) until a predetermined time has elapsed even if the illuminance has changed during the predetermined time. This prevents a situation where a user cannot see clearly a display window due to the change in the luminance at input operation time, thereby facilitating the input operation.

### BACKGROUND OF THE INVENTION

1. Field of the Invention

The present invention relates to a light controller that performs light control of a display, its method, its program, a recording medium storing the program, and a display controller.

2. Description of Related Art

A configuration has been known that controls luminance of a display device in accordance with illuminance of the area surrounding the display device (refer to, for example, Reference: JP2003-5717A, right column on page 4 to left column on page 6). The configuration described in the above Reference detects the illuminance of the area surrounding a portable electronic device with a reception unit and compares an illuminance signal from the reception unit and a luminance set-up signal of an arithmetic circuit with a comparator. The comparator then outputs a comparison result signal that increments or decrements a value of the luminance set-up signal to the arithmetic circuit until the luminance set-up signal to be input to the comparator corresponds to the detected illuminance signal. The control described above allows luminance to quickly follow illuminance in the case where illuminance changes gradually, and maintains luminance in the case where illuminance changes rapidly. Further, in the case of employing a touch panel, which is often used in relatively unstable place in terms of light, such as the use during traveling or the outdoor use, the luminance control is performed at the time of input operation through the touch panel, thereby realizing more appropriate luminance control.

However, in the configuration described in the above Reference and the like in which luminance of a display device is controlled in accordance with the illuminance of the area surrounding the device, it may occur that when a user performs input operation based on the contents displayed in the display device, the reception unit is unintentionally covered by user's hand or objects, which darken the display and makes it difficult for the user to recognize the displayed contents. As a result, the user cannot perform satisfactory input operation, for example.

### SUMMARY OF THE INVENTION

An object of the present invention is to provide a light controller capable of obtaining favorable display state at least in the time of input operation, its method, its program, a recording medium storing the program, and a display controller.

A light controller according to an aspect of the present invention includes: a light receiving section that detects illuminance in the vicinity of a display section capable of displaying various information; an input/output section that outputs a predetermined signal in response to input operation; a luminance control section that controls luminance of the display section in accordance with the illuminance detected by the light receiving section; and a light control section that restricts the control of the luminance of the display section performed by the luminance control section when recognizing output of the signal from the input/output section.

A light controller according to another aspect of the present invention includes: a light receiving section that detects illuminance in the vicinity of a display section capable of displaying various information; an input/output section that outputs a predetermined signal in response to input operation; a luminance control section that controls luminance of the display section in accordance with the illuminance detected by the light receiving section; and a light control section that allows the luminance control section to control the luminance of the display section to a predetermined value when recognizing output of the signal from the input/output section.

A display controller according to still another aspect of the present invention includes: the above-described light controller; and a display device whose luminance is controlled by the light controller.

A light control method according to yet another aspect of the present invention for controlling luminance of a display section in accordance with illuminance in the vicinity of the display section capable of displaying various information, the method includes the steps of: detecting the illuminance in the vicinity of the display section; and restricting the control of the luminance of the display section when a signal in response to input operation is recognized at the time of controlling the luminance of the display section in accordance with the detected illuminance.

A light control method according to a further aspect of the present invention for controlling luminance of a display section in accordance with illuminance in the vicinity of the display section capable of displaying various information, the method includes the steps of: detecting the illuminance in the vicinity of the display section; and controlling the luminance of the display section to a predetermined luminance when a signal in response to input operation is recognized at the time of controlling the luminance of the display section in accordance with the detected illuminance.

A light control program according to a still further aspect of the present invention executes the above-described light control method by a computer.

A recording medium according to a yet further aspect of the present invention stores the above-described light control program in a manner readable by a computer.

### BRIEF DESCRIPTION OF THE DRAWINGS

FIG. 1 is a block diagram schematically showing a navigation device having a light controller according to an embodiment of the present invention;

FIG. 2 is a front elevational view showing a display device in the embodiment of the present invention; and

FIG. 3 is a flowchart showing operation of the light control in the embodiment of the present invention.

### DETAILED DESCRIPTION OF PREFERRED EMBODIMENT(S)

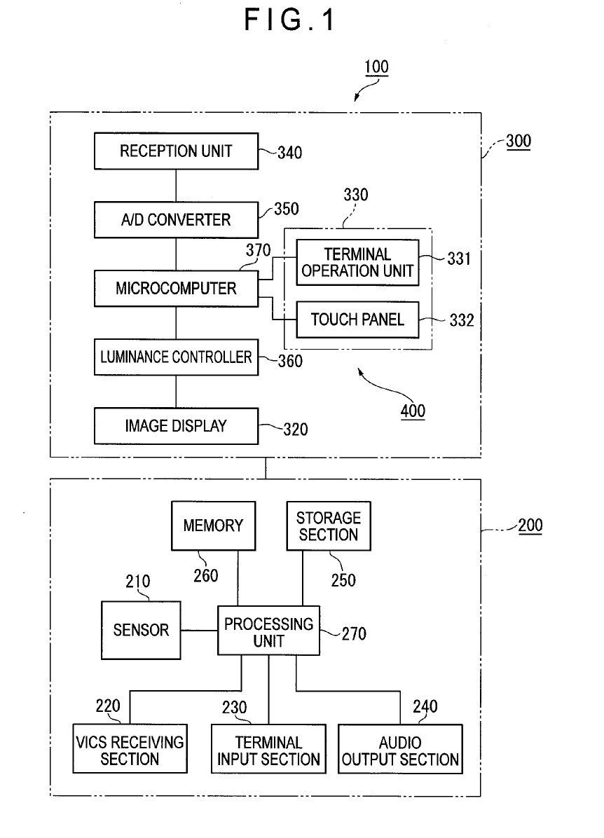

An embodiment of the present invention will be described below with reference to the accompanying drawings. In the present embodiment, a navigation device provided with a light controller according to the present invention will be exemplified. However, the present invention is not limited to this. The present invention can be applied to any configuration as far as it controls luminance of a display. FIG. 1 is a block diagram schematically showing a navigation device in the embodiment of the present invention.

In FIG. 1, reference numeral 100 denotes a navigation device. The navigation device 100 informs a driver or the like of guidance related to movement of, for example, a vehicle which is a movable body, in real-time. Note that the movable body here is not limited to a vehicle, but includes any movable body such as an airplane or a ship. As the navigation device 100, a vehicle-mounted type navigation device that is mounted on a vehicle which is a movable body, portable type navigation device, a PDA (Personal Digital Assistant), a mobile phone, a PHS (Personal Handyphone System), a portable type personal computer, and the like can be exemplified. The navigation device 100 displays information related to a current position or a destination, searches and displays routes to a destination, retrieves and displays a certain nearby store, displays information related to service contents of the store, or the like, based on map information included therein. The navigation device 100 includes, as shown in FIG. 1, a main body 200, and a display controller 300. The main body 200 includes a sensor 210, a VICS (Vehicle Information Communication System) receiving section 220, a terminal input section 230, an audio output section 240, a storage section 250, a memory 260, a processing unit 270, and the like.

The sensor 210 detects moving state of a movable body such as a vehicle, that is, a current position, driving state or the like to output a predetermined signal to the processing unit 270. The sensor 210 includes, for example, a not-shown GPS (Global Positioning System) receiving section, not shown various sensors such as a velocity sensor, an azimuth sensor, and an acceleration sensor.

The GPS receiving section receives navigation waves output from a not-shown GPS satellite which is an artificial satellite through a not-shown GPS antenna. The GPS receiving section then calculates a pseudo coordinate value of a current position based on a signal corresponding to the received navigation waves, and outputs it as GPS data to the processing unit 270.

The velocity sensor of the sensor 210 is provided on a movable body such as a vehicle, and detects driving speed or actual acceleration of the vehicle based on a signal changing with the driving speed which is the moving speed of the vehicle. The velocity sensor reads out a pulse signal or voltage value output by rotation of an axel or wheel, for example. The velocity sensor then outputs the detection information including the read out pulse signal, voltage value or the like to the processing unit 270. The azimuth sensor, which is provided on a vehicle, includes a so-called gyro sensor which is not shown and detects azimuth of the vehicle, that is, a driving direction of the vehicle. The azimuth sensor outputs a signal which is detection information related to the detected driving direction to the processing unit 270. The acceleration sensor, which is provided on a vehicle, detects acceleration in the driving direction of the vehicle. The acceleration sensor converts the detected acceleration into, for example, a sensor output value corresponding to detection information represented by a pulse or voltage value, and outputs it to the processing unit 270.

The VICS receiving section 220 has a not-shown VICS antenna and acquires information related to traffic conditions through the VICS antenna. More specifically, the VICS receiving section 220 acquires traffic information (hereinafter, referred to as VICS data) related to traffic snarl-up, traffic accident, road construction, traffic regulation or the like from a not-shown VICS via, for example, beacon or FM multiple broadcasts. The VICS receiving section 220 then outputs the acquired traffic information to the processing unit 270 as a predetermined signal.

The terminal input section 230 has an operation section including a not-shown operation button and operation knob with which a user can perform input operation. By performing input operation on the terminal input section 230, setting for operation of the navigation device 100 can be made, for example. More specifically, it is possible to perform setting of contents of information to be acquired or condition when the information is acquired, setting of a destination, retrieving of information, setting to allow driving state of a vehicle to be displayed, setting to switch or adjust display screens, or the like. The terminal input section 230 outputs, in response to the input operation corresponding to the above settings, a predetermined signal to the processing unit 270 for setting. Not only input operation through the operation section, but also input operation by voice or through an operation button or knob provided on a remote controller, the predetermined signal can be output.

The audio output section 240 has a not-shown speaker and the like. Under the control of the processing unit 270, the audio output section 240 amplifies voice data or music data from the processing unit 270 and outputs it through the speaker. The information to be output by voice includes driving direction, driving state, traffic situation and the like of a vehicle. This voice information is notified to a driver or the like as guidance for driving of a vehicle.

The storage section 250 stores map information, retrieval information for obtaining information related to a predetermined location in the map information in a readable manner. As the storage section 250, a configuration provided with a drive or driver that can read out, for storage, various information from various types of recording media including a magnetic disk such as a HD (Hard Disk), an optical disc such as a CD (Compact Disc) or a DVD (Digital Versatile Disc), a magneto-optical disk, or a memory card can be taken as an example.

The memory 260 stores, as needed, various information including settings that have been set through the input operation on the terminal input section 230, music data, image data, and the like in a readable manner. The memory 260 also stores various programs running on an OS (Operating System) that controls the entire navigation device 100. As the memory 260, it is preferable to use a memory that can hold data even when power suddenly fails due to interruption of service or the like, for example, a CMOS (Complementary Metal-Oxide Semiconductor) memory. As the memory 260, it is possible to use a configuration provided with a drive or driver that stores the information or programs in a manner that various recording media such as the HD, optical disc, memory card can read the stored information or programs.

The processing unit 270 has not-shown various I/O ports such as a VICS receiving port connected to the VICS antenna, a GPS receiving port connected to the GPS receiving section, sensor ports connected to the various sensors, a key input port connected the terminal input section 230, an audio control port connected to the audio output section 240, a storage port connected to the storage section 250, a memory port connected to the memory 260, and the like. The processing unit 270 constructs various configurations for executing various kinds of guidance in the form of various programs in accordance with the moving state of a movable body.

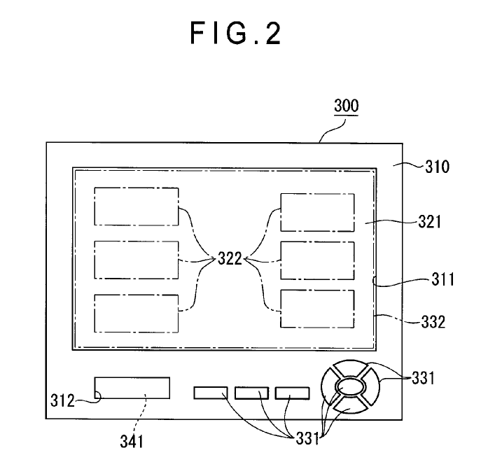

The display controller 300 is connected to the main body 200 and is operable under the control of the processing unit 270 of the main body 200. The display controller 300 has, as shown in FIG. 2, a casing 310. The casing 310 is made of, for example, synthetic resin and formed into a box-like shape having not-shown internal space. A display window 311 is open at substantially the center of the front surface of the casing 310. And, the casing 310 includes a light controller 400 of the present invention. More specifically, the casing 310 includes an image display 320 serving as a display device (display section), a terminal operating section 330 serving as an I/O section, a reception unit 340 serving as a light receiving section, an A/D (Analog/Digital) converter 350, a luminance controller 360 serving as a luminance control section, and a microcomputer 370 serving as a light control section, which constitute the display controller 300, as shown in FIG. 1. The light controller 400 of the present invention is constituted by the terminal operating section 330, reception unit 340, luminance controller 360, and microcomputer 370 and is formed on, for example, a not-shown circuit board.

The image display 320, which is controlled by the microcomputer 370, has, as shown in FIG. 2, a display surface 321 that displays image data output from the microcomputer 370. The display surface 321 is so provided within the casing 310 as to face the display window 311 of the casing 310. Examples of the image data to be displayed include image data of the map information, retrieval information and the like stored in the memory 260 or storage section 250 of the main body 200, which are supplied to the microcomputer 370 through the processing unit 270. A liquid crystal display panel, an organic EL (Electro Luminescence) panel, a PDP (Plasma Display Panel), a CRT (Cathode-Ray Tube), an FED (Field Emission Display), an electrophoretic migration display panel or the like can be taken as an example of the image display 320.

The terminal operating section 330 has, as shown in FIG. 2, a terminal operation unit 331 including plural operation buttons, operation knobs, and the like provided on the front surface of the casing 310, and a touch panel 332 provided on the display surface 321 of the image display 320. The contents to be input through the terminal operation unit 331 or touch panel 332 includes, like the case of the terminal input section 230, setting item such as various settings related to operation or display state of the navigation device 100. Input operation of the setting item through the terminal operation unit 331 or touch panel 332 outputs, as needed, a predetermined signal to the microcomputer 370 for setting. Note that FIG. 2 shows an example of a display window that displays six input items 322 for setting to prompt a user to select one or more items.

The reception unit 340 has, as shown in, for example, FIG. 2, a reception sensor 341 that faces outside through a detecting window 312 provided on the front surface or upper surface of the casing 310. The reception unit 340 receives a light in the vicinity of the display controller 300 through the reception sensor 341 to detect its illuminance, and outputs a predetermined detection signal corresponding to the illuminance to the A/D converter 350. The reception unit 340 generates a signal indicating that high illuminance has been detected in the vicinity of the display controller 300 in, for example, the daytime, that is, in the case where the amount of outside light to be received by the display controller 300 is large. On the other hand, the reception unit 340 generates a signal indicating that low illuminance has been detected in the vicinity thereof in, for example, the night and the open air, that is, in the case where the amount of outside light to be received by the display controller 300 is small. The detection signal corresponds to, for example, a level of the amount of outside light to be received.

The A/D converter 350 acquires, as an analog signal, the detection signal output from the reception unit 340 and converts it into a digital signal. The A/D converter 350 then outputs, as a digital signal, the detection signal to the microcomputer 370.

The luminance controller 360 is connected to the microcomputer 370 and controls the luminance at the time when image data is displayed on the image display 320 based on a control signal output from the microcomputer 370. The luminance controller 360 has a pre-set initial luminance control value that indicates a predetermined luminance. Based on the control signal from the microcomputer 370, the luminance controller 360 changes a current luminance value into the initial luminance control value and outputs it as a new luminance control value to the image display 320 to allow the image display 320 to display image data at a luminance value corresponding to the luminance control value.

The microcomputer 370 acquires the signal output from the processing unit 270 of the main body 200 and appropriately controls display contents or display state of the image display 320. More specifically, the microcomputer 370 acquires image data output from the processing unit 270 and applies process to the image data for display on the image display 320, or, as described above, acquires the detection signal from the A/D converter 350 to thereby recognize illuminance in the vicinity and outputs a predetermined control signal to the luminance controller 360 to allow the luminance controller 360 to set a luminance value at the time when image data is displayed on the image display 320. Further, the microcomputer 370 has a not-shown timer serving as timing section capable of measuring time.

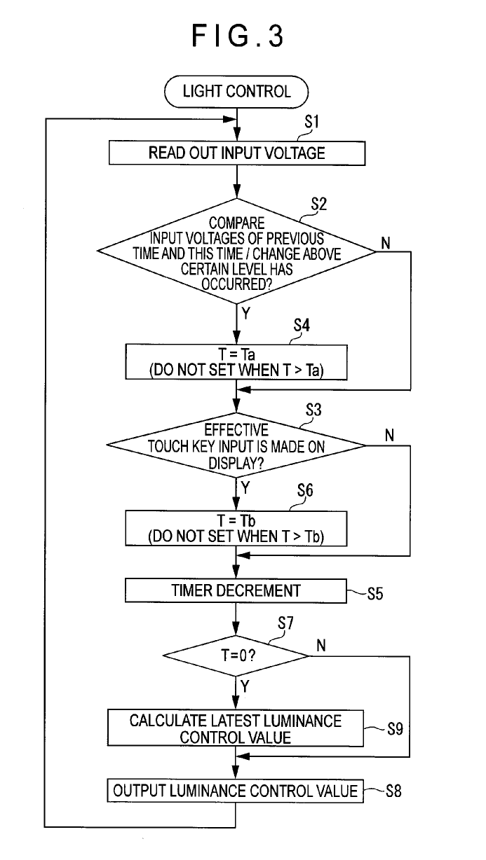

Next, a description will be given of luminance control operation in the navigation device 100 with reference to FIG. 3. FIG. 3 is a flowchart showing the operation procedure of luminance control of the display controller 300.

Firstly, a passenger of a vehicle, who is the user of the navigation device 100, turns ON the navigation device 100 and thereby power is supplied. With the supplied power, the processing unit 270 controls the display controller 300 to display a main menu including a display window to prompt the user to perform input operation of selecting one or more setting items for the operation of the navigation device 100. More specifically, when power is supplied, the processing unit 270 outputs a predetermined control signal to the microcomputer 370 of the display controller 300. The microcomputer 370 then allows the image display 320 to display a pre-set start-up window and image data corresponding to the main menu window while performing process for start-up. Note that at the start-up time, the luminance controller 360 outputs an initial luminance control value to the image display 320, so that the image display 320 displays the start-up window at the initial luminance value.

When the main menu window is displayed in the display controller 300, the navigation device 100 enters input standby state and executes light control shown in FIG. 3. That is, the microcomputer 370 detects illuminance in the vicinity of the display controller 300 with the reception unit 340 and allows the A/D converter 350 to convert, as needed, a detection signal corresponding to the detected illuminance into a digital signal for readout operation, thereby recognizing the illuminance in the vicinity of the display controller 300 based on the detection signal. In other words, the microcomputer 370 reads out an input voltage obtained when the detection signal output from the reception unit 340 is input thereto (step S1). The microcomputer 370 then outputs a predetermined control signal corresponding to the recognized illuminance to the luminance controller 360. The input voltage value is proportional to the illuminance in the vicinity of the display controller 300. That is, in the case where the reception unit 340 receives large amount of outside light, a level of the generated detection signal is correspondingly increased, with the result that input voltage value obtained at the time of inputting the detection signal is increased. On the other hand, in the case where the reception unit 340 receives small amount of outside light, a level of the generated detection signal is correspondingly decreased, with the result that input voltage value obtained at the time of inputting the detection signal is decreased. Thus, the microcomputer 370 can recognize a level of the illuminance in the vicinity of the display controller 300 by reading out the input voltage value of the detection signal to be input and outputs, as described above, a control signal corresponding to the illuminance.

Then the microcomputer 370 compares the input voltage value of the detection signal read out in a previous time and that of the detection signal read out in a current time, and determines whether or not a difference between the two input voltage values exceeds a predetermined threshold value, thereby to determine whether or not a change in the illuminance in the vicinity of the display controller 300 occurs (step S2). The predetermined threshold value used in the above procedure is appropriately set. For example, a difference in the input voltage value obtained when the display controller 300 is taken from outdoor to indoor or difference in the input voltage value obtained when the light is turned ON and turned OFF within doors is measured in advance, and the measured value is set in the microcomputer 370 as a threshold value indicating that the illuminance in the vicinity of the display controller 300 has markedly changed. That is, it is possible to recognize whether the illuminance in the vicinity of the display controller 300 has markedly changed by comparing the difference between the input voltage value read out in a previous time and the input voltage value read out in a current time with the set threshold. In the step S2, when not recognizing a change in the input voltage value, the microcomputer 370 determines whether or not input operation through the terminal operating section 330 has been made. That is, the microcomputer 370 determines presence/absence of a signal output from the terminal operating section 330 through which the input operation has been performed (step S3).

When recognizing a change in the input voltage value in the step S2, the microcomputer 370 sets time T to be measured by a timer to a predetermined time Ta (step S4). In this step, when time T that had been being set up to that time is larger than the predetermined time Ta (T>Ta), the microcomputer 370 adopts time T, and ignores the predetermined time Ta. The time Ta to be set corresponds to a first predetermined time as relatively short as, for example, one second. After that, the microcomputer 370 proceeds to the step S3, and determines whether or not input operation through the terminal operating section 330 has been made. The predetermined time Ta is the time for identifying whether or not the input voltage value has changed due to the operation performed by the user through the terminal operating section 330. That is, by delaying luminance control performed in accordance with the change in the input voltage value by the predetermined time, it is possible to determine presence/absence of the input operation within the predetermined time, thereby recognizing whether the luminance control after that time is restricted or not.

When determining in the step S3 that the input operation has not been performed, the microcomputer 370 enters into input standby state. When having determined in the step S2 that the illuminance had not changed, the microcomputer 370 determines, for example, that the user is driving a vehicle without using guidance or the user is considering about the contents to be performed by the navigation device 100. On the other hand, when having determined in the step S2 that the illuminance had changed, the microcomputer 370 determines that the user has already started a vehicle or an object is placed above the display controller 300 and thereby light is blocked to change the illuminance in the vicinity of the display controller 300. After the above determination, the microcomputer 370 executes timer decrement that counts down the time to be measured by the timer (step S5).

On the other hand, when determining in the step S3 that the input operation has been made, the microcomputer 370 determines that the user is performing various setting operations based on contents displayed on the image display 320 and sets time T to be measured to a predetermined time Tb (step S6). Note that when time T that had been being set up to that time is larger than the predetermined time Tb (T>Tb), the microcomputer 370 adopts time T, and ignores the predetermined time Tb. The time Tb to be set corresponds to a second predetermined time, which is about five seconds that generally seems to correspond to the time elapses before next input operation. After that, the microcomputer 370 advances to the step S5 and executes timer decrement.

After starting the countdown in the step S5, the microcomputer 370 determines whether or not time T, Ta or Tb to be measured becomes “0” (step S7). When determining in the step S7 that time T to be measured does not become “0”, the microcomputer 370 outputs a predetermined signal to the luminance controller 360 to allow it to output a previous luminance control value to the image display 320 (step S8). The image display 320 then performs display operation at a luminance value based on the acquired luminance control value. That is, the control of the microcomputer 370 by which the luminance controller 360 outputs a previous luminance control value to the image display 320 restricts luminance control. In other words, since luminance is set according to the previous luminance control value, the control (e.g., change) of luminance is stopped substantially. The image display 320 displays image data at a previous luminance value. After that, the microcomputer 370 returns to the step S1 and repeats this light control operation.

On the other hand, it is assumed that the microcomputer 370 has determined in the step S7 that time T, Ta, or Tb to be measured becomes “0”. In the case where the illuminance in the vicinity of the display controller 300 has changed in the step S2, microcomputer 370 outputs a predetermined signal including information related to a state in which the change has been made to the luminance controller 360. Alternatively, in the case where the illuminance in the vicinity of the display controller 300 has not changed in the step S2, microcomputer 370 outputs a predetermined signal with information indicating that the change has not occurred to the luminance controller 360. Upon receiving the signal from the microcomputer 370, the luminance controller 360 calculates luminance control value (step S9). More specifically, the luminance controller 360 calculates luminance control value based on the information related to the state in which the illuminance has changed in the step S2 to allow the luminance of the image display 320 to become brighter or darker in accordance with the detected level of illuminance. Further, the luminance controller 360 acquires a previous luminance control value based on the information indicating that the illuminance has not changed in the step S2. After that, the luminance controller 360 advances to the step S8 and outputs the acquired luminance control value to the image display 320 to allow it to perform display operation at a luminance value based on the luminance control value.

As described above, in the above embodiment, when recognizing that a predetermined signal is supplied from the terminal operating section 330, the microcomputer 370 prohibits the luminance controller 360 from performing control of the luminance at which the image display 320 displays image data in accordance with the illuminance in the vicinity of the display controller 300 detected by the reception unit 340 during a predetermined time Ta or Tb. Therefore, even if a change in illuminance to be detected has been caused due to the case where the user covers, by his or her hand or the like, the detecting window 312 through which the reception sensor 341 faces outside during input operation on the terminal operation unit 331 or touch panel 332, or the case where the user places an object above the display controller 300, luminance is not changed. This eliminates a problem of displaying unclearly. Thus, satisfactory display performance can be obtained at the input operation.

If surrounding illuminance to be detected has changed due to the shade of the user's hand or the like at the input operation, the configuration that puts a restriction on the luminance control maintains display state at an appropriate luminance value corresponding to current illuminance until a current luminance value has changed. This eliminates additional calculation of a luminance control value by recognizing input operation. As a result, it is possible to easily reduce processing load, realize high-speed processing, and simplify a configuration of the device.

Further, the above embodiment stops the luminance control at a predetermined time Ta or Tb. That is, when input operation has not been recognized during a predetermined time Ta or Tb, luminance is controlled in correspondence with illuminance. Therefore, when a predetermined time Ta or Tb has elapsed, it is determined that input operation has completed and then luminance is controlled. Thus, for example, a display window for route guidance such as one in which the self-position of a vehicle is superposed on map information is displayed at a luminance value corresponding to the illuminance in the vicinity of the display controller 300. This prevents the display window from being too bright or too dark, so that the user can see the display window in a satisfactory state. Therefore, it is possible to present the user with a display window for route guidance or the like in a good condition, thereby performing favorable guidance.

Further, the luminance control value is calculated based on an initial luminance control value in such a manner that luminance changes in accordance with the changed illuminance. Therefore, a simple calculation method in which, for example, a control value is obtained in accordance with a change in the illuminance and the initial luminance control value is adjusted with the obtained control value to calculate a luminance control value can be used. As a result, it is possible to easily reduce processing load, realize high-speed processing, and simplify a configuration of the device. Further, the configuration that calculates a luminance control value based on the initial luminance control value easily allows a modification into a simple configuration in which the initial luminance control value is output by user's input operation, easily increasing versatility.

In addition, the above embodiment executes a loop processing in which light control operation is repeated, so that a predetermined time Tb is set for each input operation. That is, each input operation restricts light control process that controls luminance, which substantially prolongs input standby state. Therefore, it is possible to prevent set luminance from being changed at operating time with a simple structure even in the case of inputting a plurality of setting items.

The above embodiment has been made in view of input operation through the touch panel 332 and is especially effective in a configuration in which the reception unit 340 is provided integrally with the display controller 300 to perform display operation at a luminance value appropriately controlled in accordance with the surrounding illuminance, and the shade of the user's hand at the time of input operation through the touch panel 332 easily changes illuminance to be detected and therefore easily changes luminance. Even in the above configuration, favorable input operation can be easily obtained.

The processing unit 270 and microcomputer 370 are configured as programs, so that it is possible to easily obtain the configuration in which the aforementioned light control can be satisfactorily performed and to easily increase availability. Further, when the program is stored in a recording medium and is read out, as needed, by a computation section, that is, a computer, map information can be readily and easily be utilized. Further, it is possible to easily handle the program, thereby increasing availability. Examples of the computation section in the present invention are not limited to a single computer, but include a configuration in which a plurality of computers are connected through a network, as well as a device such as a CPU and microcomputer and a circuit board on which a plurality of electronic parts are mounted.

### MODIFICATION OF EMBODIMENT

The present invention is not limited to the above-described embodiment, and may be modified, as described below, within a range to achieve the object of the present invention.

In the above embodiment, the navigation device 100 is used to explain the present invention. Alternatively, however, the present invention can be applied to any configuration such as a television set and personal computer as far as it is provided with the display controller 300 whose luminance is controlled by the reception unit 340. In particular, the present invention can be utilized as an input device for a card-issuing machine or a cash dispenser. Further, the present invention is applicable to a configuration that a user directly carries, such as a mobile phone, a PHS (Personal Handyphone System), a PDA (Personal Digital Assistant), a note-type personal computer.

In the above embodiment, the main body 200 and display controller 300 are separately configured. Alternatively, however, the present invention can be applied to a configuration in which the two components are integrally configured. Although an integrated configuration in which the display controller 300 includes the microcomputer 370, terminal operating section 330, and luminance controller 360 has been exemplified in the above embodiment, the image display 320 may be separately configured from the microcomputer 370, terminal operating section 330, or luminance controller 360. Further, the reception unit 340 may be separately provided near the image display 320.

Although the configuration that performs luminance control after a predetermined time Tb has elapsed has been described, another configuration may be employed. For example, a configuration that the microcomputer 370 can recognize input operation indicating that input operation has been completed may be separately provided. By this, the microcomputer 370 can recognize that the input operation has been completed. Under the condition, luminance control can be performed before a predetermined time Tb has elapsed. With this configuration, image data or the like is displayed at a luminance value corresponding to the surrounding illuminance immediately after input operation has been completed. The user can, therefore, obtain good-conditioned guidance in a prompt manner.

Although the predetermined time Ta and Tb are set at about one second and five seconds, respectively, in the above embodiment, they can be appropriately set depending on the situation. Further, the predetermined time Ta and Tb may be set such that Tb≦Ta. In this case, since Tb>Ta in the above embodiment, the process in which Tb is ignored when T>Tb in the step S6 can be omitted. Note that when Tb≦Ta, it is preferable to provide the process in which Tb is ignored when T>Tb in the step S6.

Further, it is possible to configure such that the process of reading out an input voltage from the reception unit 340 in the step S1 is looped until a change in the input voltage has been recognized and the process in the step S3 and subsequent steps is performed when illuminance has changed. With this configuration, calculation of luminance control value is not performed unless illuminance changes, so that it is possible to easily reduce processing load, realize high-speed processing, and simplify a configuration of the device.

In the above description, the luminance control value is calculated based on the initial luminance control value. Alternatively, however, the luminance control value corresponding to illuminance may be calculated using, for example, function or comparative table.

The luminance control operation performed in accordance with a change in illuminance is restricted when input operation is recognized. Alternatively, however, it is possible to configure such that when input operation is recognized, initial luminance control value is output from the luminance controller 360 irrespective of current luminance to display image data or the like at luminance in the initial state. This eliminates a timer configuration, reduces computation load, simplifies a configuration of the device and increases processing speed.

The terminal input section 230 of the main body 200 or the terminal operating section 330 of the display controller 300 has been taken as I/O section in the above embodiment. Alternatively, however, one of them may be individually employed or they may be combined. That is, I/O section is not limited to a configuration that recognizes presence/absence of input operation through the touch panel 332.

A specific configuration and procedure for implementing the present invention can appropriately be modified within a range to achieve the object of the present invention.

The priority application Number JP2003-420406 upon which this patent application is based is hereby incorporated by reference.

1. A light controller, comprising:
a light receiving section that detects illuminance in the vicinity of a display section capable of displaying various information;
an input/output section that outputs a predetermined signal in response to input operation;
a luminance control section that controls luminance of the display section in accordance with the illuminance detected by the light receiving section; and
a light control section that restricts the control of the luminance of the display section performed by the luminance control section when recognizing output of the signal from the input/output section.

2. The light controller according to claim 1, wherein the light control section prohibits the luminance control section from controlling the luminance of the display section during a predetermined time period when recognizing the output of the signal from the input/output section.

3. A light controller, comprising:
a light receiving section that detects illuminance in the vicinity of a display section capable of displaying various information;
an input/output section that outputs a predetermined signal in response to input operation;
a luminance control section that controls luminance of the display section in accordance with the illuminance detected by the light receiving section; and
a light control section that allows the luminance control section to control the luminance of the display section to a predetermined value when recognizing output of the signal from the input/output section.

4. The light controller according to claim 3, wherein the light control section allows the luminance control section to control the luminance of the display section to a predetermined value during a predetermined time period when recognizing the output of the signal from the input/output section.

5. The light controller according to claim 1, wherein the light control section allows the luminance control section to control the luminance of the display section after a first predetermined time period has elapsed when recognizing a change in the illuminance detected by the light receiving section, and prohibits the luminance control section from controlling the luminance of the display section during a second predetermined time period when recognizing, within the predetermined time period, the output of the signal from the input/output section.

6. The light controller according to claim 3, wherein the light control section allows the luminance control section to control the luminance of the display section after a first predetermined time period has elapsed when recognizing a change in the illuminance detected by the light receiving section, and prohibits the luminance control section from controlling the luminance of the display section during a second predetermined time period when recognizing, within the predetermined time period, the output of the signal from the input/output section.

7. The light controller according to claim 5, wherein the light control section prolongs the second predetermined time period when recognizing the output of the signal from the input/output section at the time when prohibiting the luminance control section from controlling the luminance of the display section during the second predetermined time period.

8. The light controller according to claim 6, wherein the light control section prolongs the second predetermined time period when recognizing the output of the signal from the input/output section at the time when prohibiting the luminance control section from controlling the luminance of the display section during the second predetermined time period.

9. The light controller according to claim 1, wherein the input/output section is a touch panel provided in a display surface of the display section in such a manner to be able to project light.

10. The light controller according to claim 3, wherein the input/output section is a touch panel provided in a display surface of the display section in such a manner to be able to project light.

11. The light controller according to claim 1, wherein the light receiving section is provided on the display section.

12. The light controller according to claim 3, wherein the light receiving section is provided on the display section.

13. A display controller, comprising:
a light controller, including:
a light receiving section that detects illuminance in the vicinity of a display section capable of displaying various information;
an input/output section that outputs a predetermined signal in response to input operation;
a luminance control section that controls luminance of the display section in accordance with the illuminance detected by the light receiving section; and
a light control section that restricts the control of the luminance of the display section performed by the luminance control section when recognizing output of the signal from the input/output section; and
a display device whose luminance is controlled by the light controller.

14. A display controller, comprising:
a light controller, including:
a light receiving section that detects illuminance in the vicinity of a display section capable of displaying various information;
an input/output section that outputs a predetermined signal in response to input operation;
a luminance control section that controls luminance of the display section in accordance with the illuminance detected by the light receiving section; and
a light control section that allows the luminance control section to control the luminance of the display section to a predetermined value when recognizing output of the signal from the input/output section; and
a display device whose luminance is controlled by the light controller.

15. A light control method of controlling luminance of a display section in accordance with illuminance in the vicinity of the display section capable of displaying various information, the method comprising the steps of:
detecting the illuminance in the vicinity of the display section; and
restricting the control of the luminance of the display section when a signal in response to input operation is recognized at the time of controlling the luminance of the display section in accordance with the detected illuminance.

16. A light control method of controlling luminance of a display section in accordance with illuminance in the vicinity of the display section capable of displaying various information, the method comprising the steps of:
detecting the illuminance in the vicinity of the display section; and
controlling the luminance of the display section to a predetermined luminance when a signal in response to input operation is recognized at the time of controlling the luminance of the display section in accordance with the detected illuminance.

17. A light control program executing by a computer a light control method of controlling luminance of a display section in accordance with illuminance in the vicinity of the display section capable of displaying various information,
the method comprising the steps of:
detecting the illuminance in the vicinity of the display section; and
restricting the control of the luminance of the display section when a signal in response to input operation is recognized at the time of controlling the luminance of the display section in accordance with the detected illuminance.

18. A light control program executing by a computer a light control method of controlling luminance of a display section in accordance with illuminance in the vicinity of the display section capable of displaying various information,
the method comprising the steps of:
detecting the illuminance in the vicinity of the display section; and
controlling the luminance of the display section to a predetermined luminance when a signal in response to input operation is recognized at the time of controlling the luminance of the display section in accordance with the detected illuminance.

19. A recording medium storing a light control program in a manner readable by a computer, the program executing by a computer a light control method of controlling luminance of a display section in accordance with illuminance in the vicinity of the display section capable of displaying various information,
the method comprising the steps of:
detecting the illuminance in the vicinity of the display section; and
restricting the control of the luminance of the display section when a signal in response to input operation is recognized at the time of controlling the luminance of the display section in accordance with the detected illuminance.

20. A recording medium storing a light control program in a manner readable by a computer, the program executing by a computer a light control method of controlling luminance of a display section in accordance with illuminance in the vicinity of the display section capable of displaying various information,
the method comprising the steps of:
detecting the illuminance in the vicinity of the display section; and
controlling the luminance of the display section to a predetermined luminance when a signal in response to input operation is recognized at the time of controlling the luminance of the display section in accordance with the detected illuminance.
